(19) United States
(12) Patent Application Publication
(10) Pub. No.: US 2020/0018105 A1
(43) Pub. Date: Jan. 16, 2020

(54) Sash window systems

(71) Applicant: Fenestration Solutions Australia Pty Ltd, Chelsea Heights (AU)

(72) Inventors: Shane Hedley McDuff, Frankston South (AU); Nigel David Proctor, Reservoir (AU); Yuri Dolgikh, Noble Park (AU); Drew Philip Anthony, Macleod (AU); David John Ackland, Rowville (AU); Adrian Jarvis, Chelsea Heights (AU)

(73) Assignee: Fenestration Solutions Australia Pty Ltd, Chelsea Heights (AU)

(21) Appl. No.: 16/509,222

(22) Filed: Jul. 11, 2019

(30) Foreign Application Priority Data
Jul. 13, 2018 (AU) AU 2018902561

(51) Int. Cl. E05D 13/00; E05D 15/16; E06B 7/22

(52) U.S. Cl. CPC E05D 13/10; E05Y 2900/148; E06B 7/22; E05D 15/165

(57) ABSTRACT

Disclosed herein are improvements for sash windows including a system which can be used with a variety of balancing systems which comprises a jamb liner being mountable in a window jamb for guiding a pair of sliding sashs, the jamb liner having a longitudinal body, the body having a front face configured such that a side of the sashs is slidably and engageably mountable thereto, and an oppositely facing rear face mountable to a recess in a side of the jamb, wherein the rear face of the body is configured such that the jamb liner is securely receivable by the recess and removable therefrom. Further disclosed is a window system having a jamb liner and a pulley device.

### RELATED APPLICATION

This present application claims priority to Australian provisional patent application no. 2018902561 filed on 13 Jul. 2019, the entire content of which is incorporated herein by reference.

### FIELD OF THE INVENTION

This invention relates to improvements for double hung sash windows, including improvements relating to a jamb liner, pulley device, clutch assembly and assemblies thereof.

### BACKGROUND OF THE INVENTION

Double-hung sash windows are a popular window choice. These windows generally have a window casing which supports the upper and lower sashes via jamb liners set into the vertical jambs of the window casing. The jamb liners house hardware for balancing the windows which allow them to be opened easily, usually by sliding up and down the tracks formed in the vertical jambs. This hardware can be in the form of counter weight systems or balancing systems, such as constant force springs, counterbalance pulley systems, block and tackle or hybrid spiral balances.

Furthermore, jamb liners used with balancing systems other than the block and tackle generally must be nailed or screwed to the window casing which increases labour and time to install or replace a window.

To fit a specific balancing system, a specific frame and/or window and/or jamb liner must be fabricated for that balancing system and is generally not interchangeable with another double sash window system using another balancing system. Thus decisions in relation to a type of balancing system used must be made early in construction planning in order to set up each window system individually, and to change the balancing system at any time thereafter can be labour intensive, awkward and generally inflexible.

A similar situation exists if a home owner wishes to retro-fit or replace an existing balancing system with a different balancing system, for example in a heritage or older building. Different hardware and/or jamb liner is typically required which may at least necessitate altering the slot or track in the jamb adding to the expense and time required or in some cases may require replacement of the entire window casing.

In addition, jamb liners are generally formed of polyvinylchloride (PVC) or aluminium, which is typically incongruent to the frame of the window unit which is generally formed of wood or painted wood. The applicant has found that the visible portion of the PVC or aluminium jamb liner is generally considered unsightly and undesirable, especially if these jamb liners are used in restoration or construction of period homes such as those in the Georgian or Victorian style.

A common piece of hardware used in counter weight balancing systems is the twin-wheel counterbalance pulley. A common problem with this system is that it requires a recess to be formed in the head of the window therefore increasing labour and complexity of installation.

Furthermore, prior art devices such as a tilt latch is used to hold the top of the sash window to a pulley where the tilt latch has a tongue-like element which can be retracted or extended so as to be able to disengage or engage the top of the sash to facilitate its removal or installation. The applicant has concerns that use of the tilt latch causes undesirable and unwanted detachment of the sash during normal operation.

Moreover, these window systems utilize a clutch connection or fasten the cord, typically via a screw to a counter-balance to suspend the sash window. There are multiple way of connection, and therefore are inconvenient and time-consuming when replacing or retro-fitting the windows especially when changing to a different balancing system. As the cord connection depends on the balancing system then replacing or changing balancing systems requires changing the connection of the sash to the balance as well or requires removal or replacement of the entire window system.

Examples of the invention seek to solve or at least ameliorate one or more disadvantages of previous systems for suspending sash windows, including jamb liners or jamb liner assemblies or components associated therewith.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to a first aspect of the present invention there is provided a system for sash windows comprising a jamb liner being mountable in a window jamb for guiding a pair of sliding sashs having a longitudinal body, the body having a front face configured such that a side of the windows are slidably and engageably mountable thereto, and an oppositely facing rear face mountable into a recess in a side of the jamb, wherein the rear face of the body is configured such that the jamb liner is securely receivable by the recess and removable therefrom.

Preferably, the rear face has a fin member extending laterally therefrom being engageable in a channel formed in the recess. More preferably, the or each fin member is a longitudinal fin member.

According to an embodiment, the front face has a fin member extending laterally therefrom and being oppositely directed to the fin member of the rear face, the fin member configured to engage a slot of a cover member such that, when the fin member is so engaged, the cover member extends between window sides. More preferably, the or each fin member is a longitudinal fin member. Even more preferably, the cover member is a longitudinal fin member.

Preferably, the or each fin member has at least one longitudinal ridge hook portion at an end portion thereof, the at least one ridge hook portion being formed of a resilient material thereby providing a biasing force for securably engaging the fin member when it is so received in the channel or slot.

Preferably, the or each fin member has a pair of ridge hook portions, extending laterally to an axis of the fin member and on opposite sides thereof.

According to an embodiment, the front face has a pair of spaced apart guide channels, each guide channel configured to receive at least part of a window suspending and balancing mechanism therein. Preferably, the guide channels are longitudinal guide channels.

According to an embodiment, each guide channel has a pair of inwardly directed longitudinal flanges, the front face of an inner flange of each channel having a longitudinal holding channel, wherein each holding channel is configured to receive a weatherproofing member such that, when the members is so received in the holding channels, each waterproofing member extends between the jamb liner and the associated window thereby providing weather protection.

According to another aspect of the present invention, there is provided a jamb liner assembly or system for sash windows having a jamb liner and a pulley device, the jamb liner and pulley device being mountable in a window jamb for suspending and balancing a pair of slidable sashes, the pulley device having a frame for supporting a pair of pulleys, a base of the pulley device frame being mateably engageable with a top end portion of the jamb liner, and wherein the jamb liner and pulley device, when so engaged, are configured to fit within a recess in a corresponding jamb side. Preferably, the top surface of the pulley device is substantially flush with or below the bottom surface of a head of the window.

According to an embodiment, there is provided a jamb liner as described above for use or when used in a jamb liner assembly or system as described above.

According to a still further aspect of the present invention, there is provided a pulley device for use in a jamb liner assembly or system as described above, wherein the pulley device has a frame for supporting a pair of pulleys, a base of the pulley device frame being mateably engageable with a top end portion of a jamb liner configured to be mounted in a side of a jamb of a window, and wherein the jamb liner and pulley device, when so engaged, are configured to fit within a recess in a corresponding jamb side.

According to an embodiment, the top surface of the pulley device is substantially flush with or below the bottom surface of a head of the window.

According to an embodiment, the base of the pulley device frame has a pair of downwardly facing openings, wherein the base openings and upwardly facing openings defined by a top surface of the guide channels are in registry so as to allow a cord attached at each end to one of the sashes to pass upwardly through one base opening and associated guide channel opening and pass over the pulleys and into the other base opening and associated guide channel opening thereby allowing vertical operation of the windows.

According to an embodiment, the pulley device frame has a pair of spaced apart walls extending upright from the base, and a pair of axles extending between the walls for suspending the pulleys thereon.

According to an embodiment, the pulley device has a fin member extending laterally from the rear face, wherein the fin member is receivable in a channel of the recess of the jamb.

Preferably, one of the walls is a rear wall configured to engage with the recess of the jamb side.

Preferably, the rear wall of the pulley device has at least one hole for receiving a fastener.

Preferably, the rear wall has a pair of holes, each hole at opposing side portions of the pulley device for receiving fasteners.

According to an embodiment, a portion of a front wall opposite the rear wall at each hole is cut-away so as to allow easy access to the or each fastener.

According to an embodiment, the pulley device has at least one holding channel on an outwardly portion of the frame, wherein each holding channel is in registration with at least one holding channel of the jamb liner and configured to receive the weatherproofing member held in the jamb liner such that, when the weatherproofing members are so received in the holding channels, each waterproofing member extends between the pulley device and the associated sash thereby providing weather protection.

According to an embodiment, the jamb liner assembly including a retaining element wherein the or each holding channel of the pulley device or the jamb liner is also configured so as to receive a portion of a retaining element and wherein another portion of the retaining element is configured to be fastened to an upper edge of the sash.

According to a further aspect of the present invention, there is provided a clutch assembly for suspending a sash, the clutch assembly having a cord holding portion for gripping a cord to suspend the sash, wherein the cord holding portion has a passageway having a cover portion for covering an opening of the passageway, the passageway having projections and wherein, when the cover portion is receiving in the opening, the cord is grippable between the projections and the cover portion.

Preferably, the projections are in the form of a pair of parallel rows, each row having spaced-apart teeth-like projections.

According to yet another aspect of the present invention, there is provided a cover member for use or when used with the jamb liner assembly as described above.

According to further aspects of the present invention, there is provided a kit having a jamb liner as described or jamb liner assembly as described above and any one of the following selection of balancing mechanisms: block and tackle, constant force spring, counterbalance pulley and hybrid spring balance, and/or a cover member as described above, wherein the jamb liner is configured to be used with any one of those balancing mechanisms interchangeably.

According to still yet another aspect of the present invention, there is provided a kit having a system or a jamb liner, jamb liner assembly and/or pulley device, clutch assembly and/or a cover member as described above.

### BRIEF DESCRIPTION OF THE DRAWINGS

The present invention will now be described, by way of non-limiting example, with reference to the accompanying drawings in which:

FIG. 1 is a front view of a double hung sash window;

FIG. 2 is a cross-section of the window through line A-A of FIG. 1 illustrating a jamb liner according to a preferred embodiment of the present invention;

FIGS. 3 to 5 are perspective, front and cross-section views respectively of the jamb liner of FIG. 2;

FIG. 6 is a perspective view of the jamb liner of FIGS. 2 to 5 with a pulley device according to a further preferred embodiment of the present invention;

FIGS. 7a and 7b are top and side views of FIG. 6 having a retaining component having perspective and side views as shown in FIGS. 7c and 7d;

FIG. 8 is a perspective view of the pulley device of FIGS. 6, 7a and 7b;

FIG. 9 is a perspective view of a cover member for use with the jamb liner of FIGS. 2 to 6;

FIG. 10 is a cross-section view through dotted line B-B of a cover member of FIG. 9;

FIG. 11 is a perspective view of a cord adapter assembly according to yet another preferred embodiment of the present invention;

FIG. 12 is a perspective view of a cord adapter assembly of FIG. 11 and clutch assembly;

FIGS. 13 and 14 are top and bottom views of the cord adapter assembly of FIGS. 11 and 12; and

FIGS. 15 and 16 are cross-section views of the cord adapter assembly of FIGS. 11 to 14 through lines C-C and D-D respectively; and

FIG. 17 is a perspective view of the cord adapter assembly of an alternative cord adapter assembly

### DETAILED DESCRIPTION OF THE INVENTION

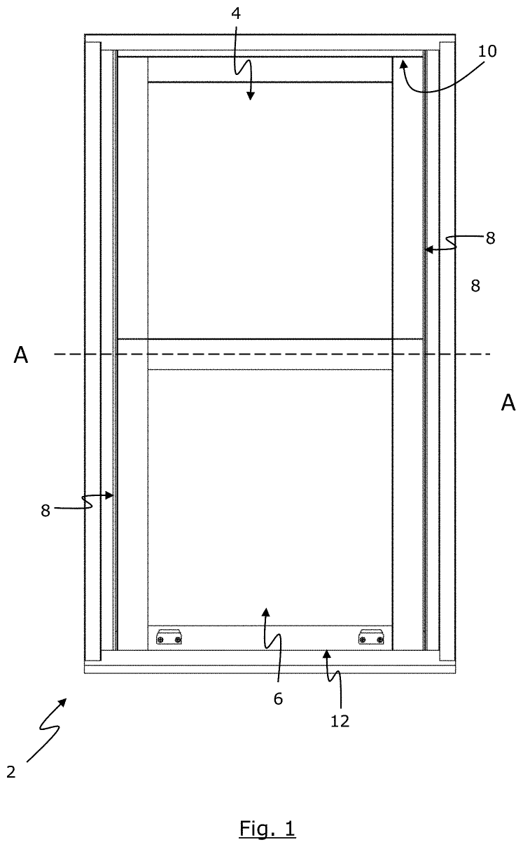

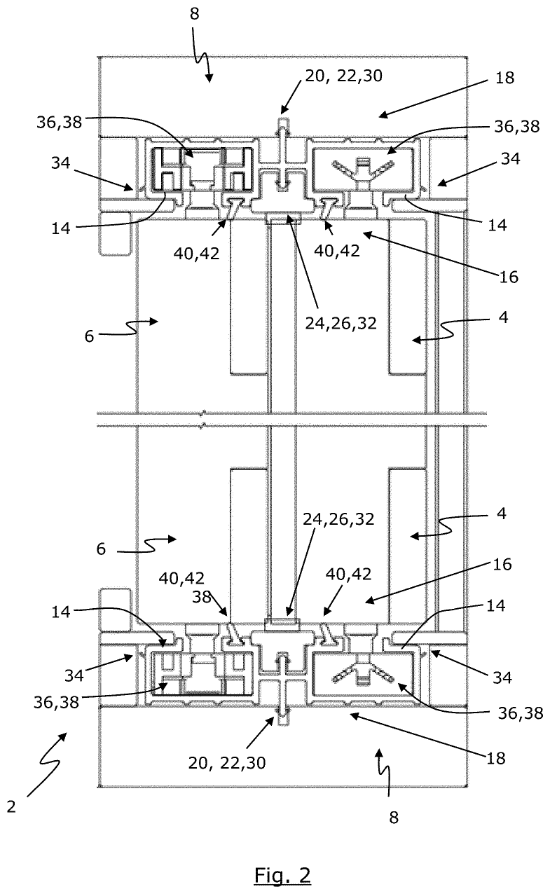

FIG. 1 shows double-hung sash window 2 which has upper and lower sliding sashes 4, 6 which are supported by a window casing comprising a pair of upright jambs 8 at its sides bridged at the top and bottom by a head 10 and sill 12 respectively. FIGS. 2 to 6 are various views of a jamb liner 14 according to a preferred embodiment of the present invention for use in the double-hung sash window 2 as shown in FIG. 1. A pair of jamb liners 14 are mountable in the window casing, one in each jamb 8, the jamb liners 14 being for guiding and supporting the sliding sashes 4, 6 therein.

Each jamb liner 14 has a longitudinal body having oppositely directed front and rear faces 16, 18. The front face 16 is configured such that sides of the sashes 4, 6 are slidably and engageably mountable thereto. The rear face 18 is configured such that it is mountable in a recess in an inwardly facing side of the jamb 8. In particular, the jamb liners 14 are securely receivable by a recess in the jamb 8 and also removable for ease of installation and replacement of the window 2. The rear face 18 of the jamb liner 14 has a first longitudinal fin member 20 which extends laterally therefrom and which is configured to engage and be received in a corresponding vertically oriented channel 22 provided in the recess of the jamb 8.

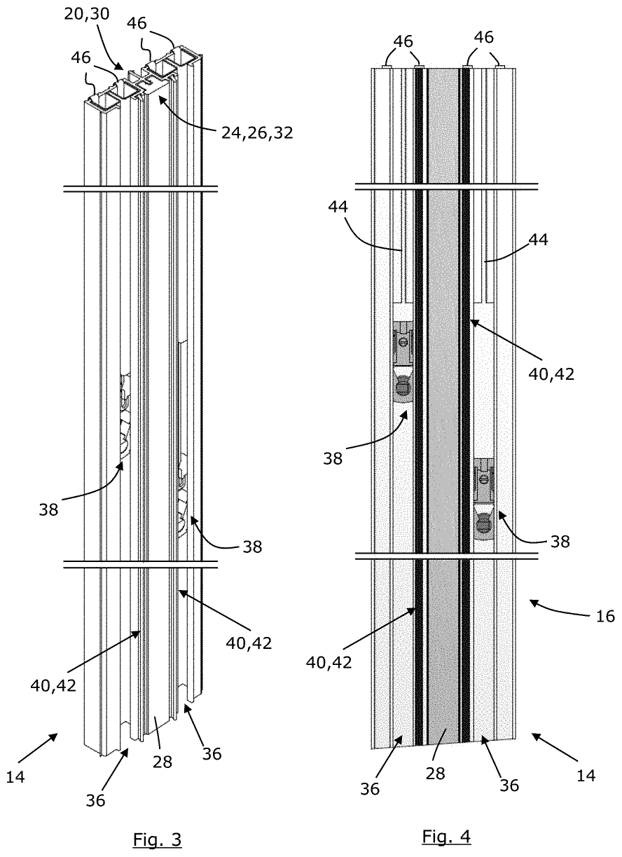

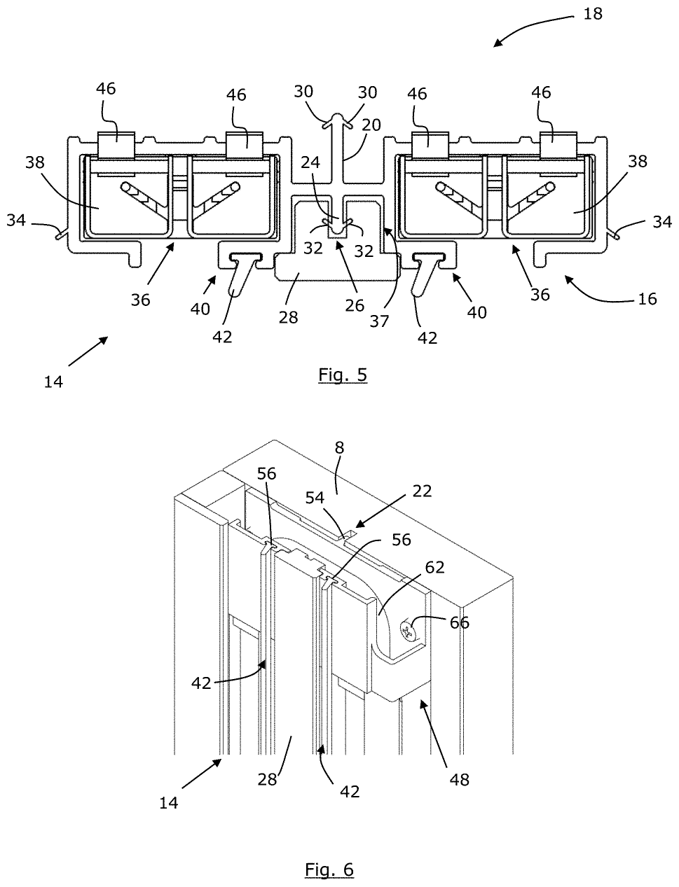

The jamb liner 14 has a second longitudinal fin member 24 which extends laterally from the front face 16. In a preferred embodiment illustrated in FIG. 5, the inner walls of the guide channels 36 themselves form a longitudinal channel 37, into which a cover member 28 can be engageably received, and where the second fin member 24 extends parallel to and intermediate the inner walls. The second fin member 24 is directed oppositely to the first longitudinal fin member 20 and is configured to be received in a longitudinal slot 26 of a cover member 28. The cover member 28 is configured so as to be slidably receive the second fin member 24 and, when so received, advantageously provides an aesthetically pleasing veneer between the front and rear sashes 4, 6.

In an example, the cover member 28 can have a surface material or can be formed with a material which substantially matches the material of the sashes 4, 6 or the window casing, for instance a timber veneer or other types of veneer which is more aesthetically pleasing. Furthermore, the concealment of the PVC or aluminium jamb liner is generally desirable to provide a window with a high quality polished appearance which is in keeping with the overall look of a house, especially if the house is in a period style which typically has sash windows, such as houses built in the Georgian or Victorian style.

An end portion of each fin member 20, 24 has a pair of ridge hook members 30, 32 extending on opposite sides laterally from an axis of the fin members 20, 24 and substantially along the length of the fin members 20, 24. The ridge hook members 30, 32 are formed of a resilient material. Thus when longitudinal fin member 20, 24 is received in the corresponding recess channel 22 or longitudinal cover member slot 26, the resilient ridge hook members 30, 32 engage the sides of the channel or slot 22, 26 and provide a biasing force to securably engage the fin member 30, 32 therein.

The longitudinal fin member 20, 24 and ridge hook members 30, 32 advantageously provide a means of engageably and removably mounting the jamb liner 14 in the jamb side or the cover member 28 which securely holds the jamb liner 14 but is also easy to install and un-install. Thus the jamb liners 14 are configured to allow convenient and easy installation, un-installation, servicing and replacement not only by a professional technician but also by home owners or other non-professional users.

The jamb liner 14 can also have a pair of resilient longitudinal side fin members 34 which extend from the jamb liner sides and which are angled towards the front face 16 for engaging the sides of the recess of the jamb and which assist to hold the jamb liner 14 in place.

The jamb liner 14 has a pair of longitudinal guide channels 36 having inwardly directed open ends which are configured to receive at least part of any of the following window suspending and balancing mechanisms therein. Examples of the window suspending and balancing mechanisms that can be received in the guide channels include block and tackle mechanism 38 as exemplified in FIGS. 2 to 5, hybrid spiral mechanisms, constant force mechanisms and pulley mechanisms as will be described further in the paragraphs below.

Thus advantageously the present jamb liner can be used with any pre-selected balancing mechanism. As specific frames and/or jamb liners do not have to be fabricated for each specific balancing mechanism, the home owner or house builder has an increased flexibility and choice in selecting the type of balancing mechanisms which they may wish to use right up to the point of installation of the window. Furthermore, there are increased efficiencies in the planning and resourcing stages of construction of the building as the window systems can be planned and set up from the commencement of the project and no additional re-work is required if a different balancing system is selected thereafter.

Each guide channel 36 has a pair of inwardly directed longitudinal flanges, the front face of an inner flange of each channel 36 having a longitudinal holding channel 40. Each longitudinal holding channel 40 is configured to receive a weatherproofing member 42 such that, when the members are so received, each waterproofing member 42 extends between the jamb liner 14 and the associated sash 4, 6 preventing air ingress and thereby providing weather protection.

In the example of FIGS. 2 to 5, the jamb liner 14 has a block and tackle mechanism 38 which has spring balances 44 which are fastened to the jamb liner 14 via fasteners 46, such as S-clips.

The jamb liner 14 is preferably formed by extrusion and can comprise a flexible polymer, for example poly vinyl chloride (PVC) which is thermally efficient, and cheap and easy to extrude. Alternatively, the jamb liner 14 can be formed of a metal, such as aluminium.

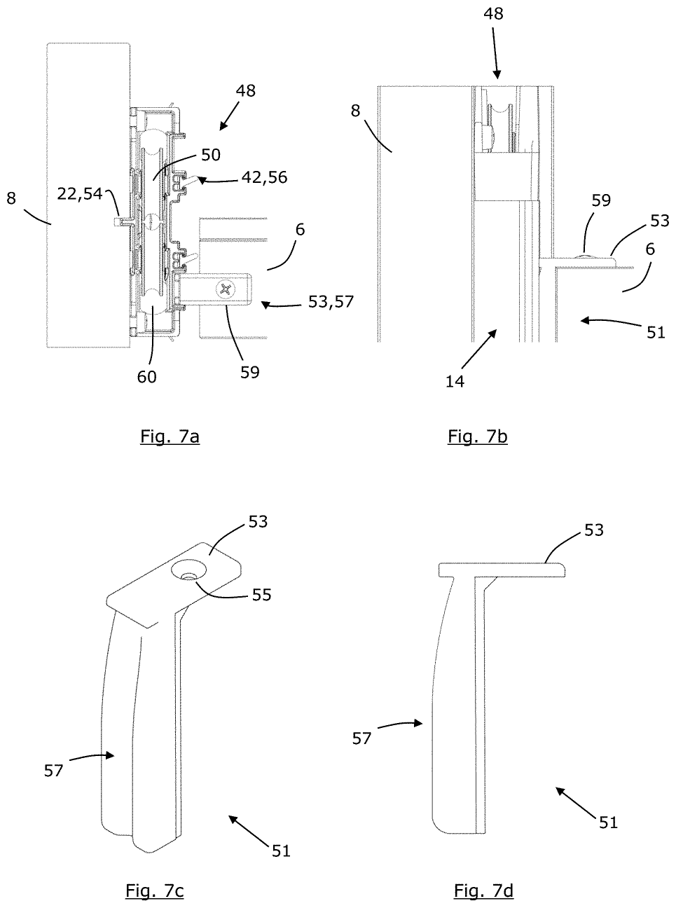

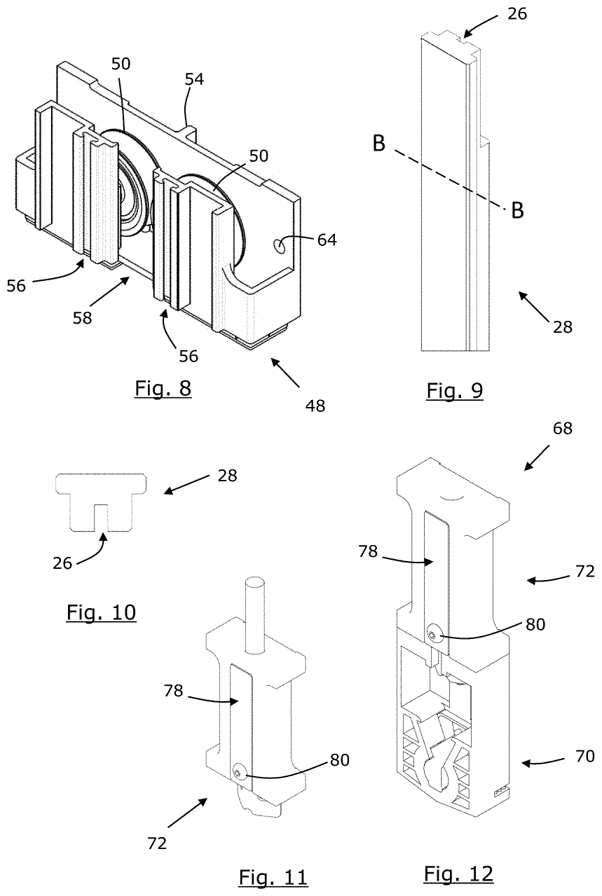

FIGS. 6 to 10 show the jamb liner 14 as described above used with a pulley device 48 according to a further preferred embodiment of the present invention. Although the pulley device 48 is illustrated in the Figures with the jamb liner as described, it will be understood that this is a mere example and that the pulley device 48 could be configured for use with other available jamb liners.

FIG. 6 shows that the pulley device 48 has a frame for supporting a pair of pulleys 50. The frame has a pair of spaced apart walls extending upwardly from a base, and where the pulleys 50 are rotatably supported on a pair of axles 52 which are spaced apart and extend between the walls. The base of the frame is configured to be mateably engageable with the top portion of the jamb liner 14 such that when the jamb liner 14 and pulley device 48 are received in the recess of the jamb 8, the uppermost surface of the pulley device 48 is flush with the lower surface of the window head 10. In particular, the bottom surface of the base is contoured so as to mate with the top portion of the jamb liner 14, for example the openings defined by the top portion of the guide channels 36. Advantageously, the jamb liner 14 and pulley device 48 can be used without altering the head 10 of the window which can be labour-intensive and costly, and does not damage the window head 10.

The frame of the pulley device 48 is preferably formed of a rigid polymer material which can support the pulleys 50 therein.

The outwardly directed side of the rear wall of the pulley device 48 is configured to engage and be received in the recess channel 22. In particular, the rear wall has a first longitudinal fin member 54 extending laterally therefrom to be received in the corresponding recess channel 22. The outwardly directed side of the front wall is configured to engage a side of the sashes 4, 6.

As illustrated in the Figures, the fin member 54 of the pulley device 48 and the rear fin member 20 of the jamb liner 14 is in registration, so as to allow the mated combination of the jamb liner 14 and pulley device 48 to be securably engaged in the recess channel 22 along its entire longitudinal length. Similarly, the front face of the pulley device 48 has a pair of holding channels 56 which are in registration with the holding channels 40 of the jamb liner 14 so as to allow the weatherproofing members 42 to be received therein along the entire longitudinal length of the jamb liner 14 and pulley device 48 when they are mated together.

The front wall of the pulley device 48 has a longitudinal opening 58 configured to receive a top portion of the cover member 28, such that, similar to the arrangements for the weatherproofing members 42 and fin members 20 and 54, the slot of the cover member 28 is able to engage the entire length of the jamb liner and pulley device mounted thereon.

The base of the frame has a pair of downwardly facing openings 60, and the pulleys 50 are arranged such that the outer edges of the pulleys 50 are in registry with the base openings 60. The openings 60 are also arranged such that they are in registry with the upwardly directed openings of the top of the guide channels 36 of the jamb liner 14 such that a cord 62 can be received over the pulleys 50 and extend downwardly on either side through each pair of openings to suspend the sashes and allow vertical operation thereof.

The rear wall of the pulley device 48 has openings 64 which are configured to receive fasteners for securing the pulley device 48 to the recess of the jamb 8. As illustrated in FIG. 6 to 8, the openings 64 are preferably located at the sides of the pulley device 48. For further reinforcement, an additional opening (not shown) can be provided near the base between the pulleys 50. A portion of the front wall is cutaway opposite to the openings 64 so as to allow the fasteners 66, for example screws, to be installed and removed from the openings 64 easily.

Once the jamb liner 14 and pulley device 48 holding the sashes 4, 6 have been installed in the jamb 8, the top of the sash can be fixed into position by a retaining component 51 as illustrated in FIGS. 7a to 7d. The retaining component 51 has a first portion 53 which is configured to be attached to a side edge of the upper part of the sash 4, 6. In particular, the first portion 53 has an aperture 55 which can receive a fastener, such as a screw thereby securely attaching the retaining component 71 to the sash. Extending downwardly from an end of the first portion 53 is a second portion 57 which is configured to be engaged to the pulley device 48 and/or jamb liner 14. In another embodiment, the portion 55 may be configured so as to engage with one or the other of the pulley device 48 or jamb liner 14 depending on the configuration of the window. Although in this example, the retaining component 51 is used with the pulley balancing mechanism, the retaining component can be used with any balancing mechanism.

In particular, the second portion 57 has a profile which is configured to allow it to be securely engaged within the holding channels 40, 56 of the pulley device 48 and/or jamb liner 14. Therefore, in use, the retaining component 51 is engaged to the pulley device 48 or jamb liner 14 by sliding the second portion 57 into the holding channel 40, 56. Then the retaining component 51 can be securely fastened via fastener 59 to the upper edge of the sash 4, 6 and advantageously holds the sash 4, 6 securely until removal or de-installation is required. As discussed above the applicant has concerns that use of the tilt latch could cause undesirable and unwanted detachment of the sash during normal operation, and the proposed retaining component 51 advantageously retains the sash more securely and decrease the risk of unwanted detachment.

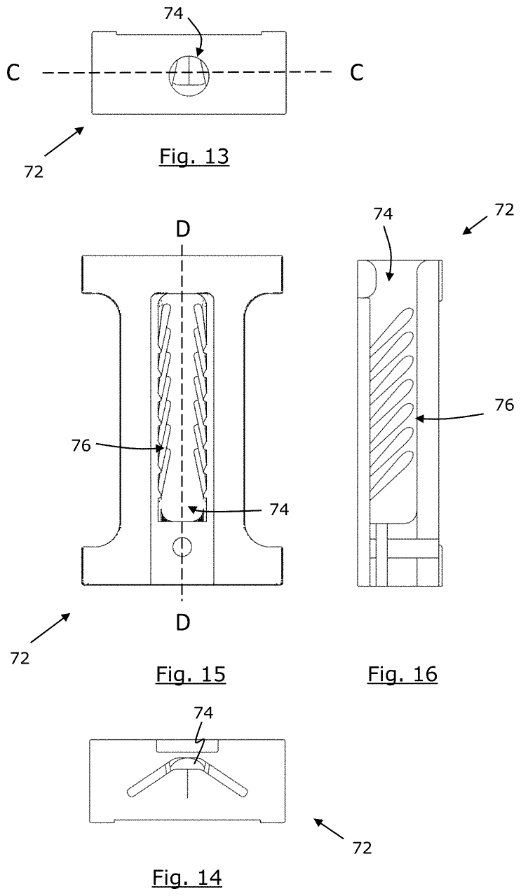

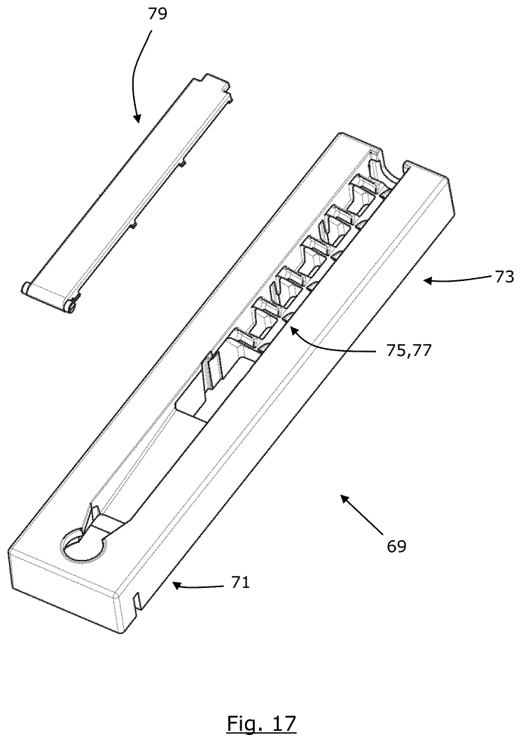

As illustrated in FIGS. 13 to 16, the ends of the cord 62 can be held in a clutch assembly 68, 69 which is arranged so as to be slidable within the guide channels 36 of the jamb liner 14. The clutch assembly 68, 69 has an adjustable clutch 70, 71 which allows friction adjustment and braking, and which allows the insertion of a pivot pin (not shown). The pivot pin can be rotated from one position which permits removal or installation of the sash 4, 6 to another position in which prevents removal or installation of the sash 4, 6. The function of the adjustable clutch 70, 71 and pivot pin are well known and therefore not described further in this disclosure.

The top portion of the clutch assembly 68, 69 is a cord adapter device 72 which can be formed separately to the adjustable clutch 70, 71 (as shown in FIGS. 11 to 16) or alternatively the clutch assembly 69 can comprise the adjustable clutch 71 (as shown in FIG. 15) being formed integral to the cord adapter portion 73. The cord adapter device or potion 72, 73 holds and feeds the cord into the adjustable clutch 70, 71, and advantageously replaces the need to fasten the cord directly to the sash window. The clutch assembly therefore allows the sash window to be detached from the balancing mechanism without requiring removal of the entire window system or alternatively convenient and easy replacement, maintenance or retro-fitting of another type or new balancing system to the window without replacement of the jamb liner.

The cord adapter device or portion 72, 73 has a body having top and bottom oppositely facing surfaces, and a longitudinal passageway 74, 75 therebetween for receiving the cord 62. A portion of the inner surface of the passageway 74, 75 having a cleat portion 76, 77 and a portion of the passageway 74, 75 opposite the cleat portion 76, 77 having a clamp member 78 or cover member 79 for clamping the cord 62 when it is so received in the passageway 74, 75 onto the cleat portion 76, 77, thereby securing it in the cord adapter device or portion 72, 74. As illustrated most clearly in FIGS. 15, 16 and 17, the cleat portion 76, 77 comprises elongate or teeth-like projections configured to securely hold the cord thereby securing connecting it to the clutch assembly 68, 69 when clamp member 78 is in the form of a metal plate which is clamped onto the cord 62 received in the cleat portion 76 by a fastener 80. Alternatively, the cover member 79 can snap shut or otherwise fasten over the cord 62 in cleat portion 77. Preferably, the projections are aligned so as to form two parallel rows of spaced-apart teeth which are angled upwardly and away from the opening of the passageway 74. A further fastener (not shown) can be provided for attaching the cord adapter device 72 to the adjustable clutch 70, formed separately to the cord adapter device 72.

It will be appreciated that the disclosure above relates to a universal window system and jamb liner which can be used across a range of balancing mechanisms and which has been configured to allow easy and convenient replacement, retro-fitting, maintenance or exchange of one balancing system to another system without necessitating replacement of the entire window or jamb liner as is the case with the prior art existing systems and jamb liners. This also simplifies installation and maintenance for the technicians as the same components are used, i.e. jamb liner, clutch assemblies, retaining element, are used for all balancing mechanism types, which also provides cost reductions and efficiencies in manufacturing.

As an example of use, a sash window system 2 as described above using a constant force spring or spiral balancing mechanisms can easily converted to a pulley balancing mechanism by simply removing the sash windows 2 by first removing the retaining elements 51, detaching the sash windows 4, 6 from the clutch assemblies 68, 69 and jamb liner 14, removing the jamb liners 14 and balancing mechanisms from the recesses formed in the jamb sides 8, cutting a portion of the length of the jamb liners 14 such that the pulley device 48 and jamb liner 14 when engaged together are fittable into the recesses without necessitating damage or otherwise altering the head 10 of the window, fitting the cord 62 and clutch assemblies 68, 69 into the jamb liner 14 and simply re-attaching the sash windows 4, 6 to the clutch assemblies 68, 69 and then securing the sashes 4, 6 via the use of the retaining elements 51. A similar process can be utilised to replace a pulley balancing system with another balancing system in the same window however only a replacement jamb liner would be required which has the same length as jamb liner and pulley device combined. Notably and advantageously, the same window system 2 is utilised for all balancing mechanism types.

Although the above description and the Figures refer to a double-hung window 2, it will be appreciated that the embodiments of the present invention can be easily modified to be suitable for a window with a single sliding sash.

Preferred features of the present invention will now be described with particular reference to the accompanying drawings. However, it is to be understood that the features illustrated in and described with reference to the drawings are not to be construed as limiting on the scope of the invention.

Through-out the specification and claims the word “comprise” and its derivatives is intended to have an inclusive rather than exclusive meaning unless the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the assembly uppermost.

It will be appreciated by those skilled in the art that many modifications and variations may be made to the methods of the invention described herein without departing from the spirit and scope of the invention.

What is claimed is:

1. A system for sash windows, comprising: a jamb liner being mountable in a window jamb for guiding a pair of sliding sashs, the jamb liner having a longitudinal body, the body having a front face configured such that a side of the sashs is slidably and engageably mountable thereto, and an oppositely facing rear face mountable to a recess in a side of the jamb, wherein the rear face of the body is configured such that the jamb liner is securely receivable by the recess and removable therefrom.

2. A system according to claim 1, wherein the rear face of the body has a fin member extending laterally therefrom being receivable in a channel formed in the recess.

3. A system according to claim 1, including a cover member wherein the front face of the jamb liner has a fin member extending laterally therefrom, the fin member configured to engage a cover member such that, when the fin member is so engaged, the cover member extends between the sashs.

4. A system according to claim 2, wherein the or each fin member is a longitudinal fin member.

5. A system according to claim 4, wherein the or each fin member has at least one ridge hook portion at an end portion thereof, the at least one ridge hook portion being formed of a resilient material thereby providing a biasing force for securably engaging the fin member when it is so received in the channel or slot.

6. A system according to claim 5, wherein the or each fin member has a pair of ridge hook portions, extending laterally to an axis of the fin member and on opposite sides thereof

7. A system according to claim 1, wherein the jamb liner has a pair of spaced apart guide channels, each guide channel configured to receive at least part of a window suspending and balancing mechanism therein.

8. A system according to claim 7, wherein each guide channel has a pair of inwardly directed flanges, the front face of an inner flange of each channel having a holding channel, wherein each holding channel is configured to receive a weatherproofing member such that, when the members are so received in the holding channels, each waterproofing member extends between the jamb liner and the associated sash thereby providing weather protection.

9. A system for sash windows, comprising: a jamb liner for guiding a pair of sliding sashs and a pulley device, the jamb liner and pulley device being mountable in a window jamb for suspending and balancing a pair of slidable sashes, the pulley device having a frame for supporting a pair of pulleys, a base of the pulley device frame being mateably engageable with a top end portion of the jamb liner, and wherein the jamb liner and pulley device, when so engaged, are configured to fit within a recess in a corresponding jamb side wherein the top surface of the pulley device is substantially flush with or below the bottom surface of a head of the window.

10. A system according to claim 9, wherein the pulley device having at least one holding channel on an outwardly portion of the frame, wherein each holding channel is in registration with at least one holding channel of the jamb liner and configured to receive the weatherproofing member held in the jamb liner such that, when the weatherproofing members are so received in the holding channels, each waterproofing member extends between the pulley device and the associated sash thereby providing weather protection.

11. A system according to claim 10 including a retaining element, wherein the or each holding channel of the pulley device or the jamb liner is also configured so as to receive a portion of the retaining element and wherein another portion of the retaining element is configured to be fastened to an upper edge of the sash.

12. A pulley device for use in the system according to claim 9, the pulley device having a frame for supporting a pair of pulleys, a base of the pulley device frame being configured to be mateably engageable with a top end portion of the jamb liner, and wherein the jamb liner and pulley device, when so engaged, are configured to fit within a recess in a corresponding jamb side.

13. A pulley device according to claim 12, wherein the top surface of the pulley device is substantially flush with or below the bottom surface of a head of the window.

14. A pulley device according to claim 12, wherein the base of the pulley device frame has a pair of downwardly facing openings, wherein the base openings and upwardly facing openings defined by a top surface of the guide channels are in registry so as to allow a cord attached at each end to one of the sashes to pass upwardly through one base opening and associated guide channel opening and pass over the pulleys and into the other base opening and associated guide channel opening thereby allowing vertical operation of the sashs.

15. A pulley device according to claim 12, wherein the pulley device frame has a pair of spaced apart walls extending upright from the base, and a pair of axles extending between the walls for suspending the pulleys thereon.

16. A pulley device according to claim 15, wherein one of the walls of the pulley device is a rear wall configured to engage with the recess of the jamb side, and wherein the pulley device has a fin member extending laterally from the rear face, wherein the fin member is receivable in a channel formed in the recess of a respective jamb.

17. A pulley device according to claim 16, wherein the rear wall of the pulley device has at least one hole for receiving a fastener for attaching the pulley device to the jamb.

18. A pulley device according to claim 17, wherein a portion of a front wall opposite the rear wall at each hole being cut-away so as to allow easy access to the or each fastener.

19. A clutch assembly for suspending a sash, the clutch assembly having a cord holding portion for gripping a cord to suspend the sash, wherein the cord holding portion has a passageway having a cover portion for covering an opening of the passageway, the passageway having a cleat portion therein and wherein, when the cover portion is receiving in the opening, the cord is grippable between the projections and the cover portion.

20. A clutch assembly according to claim 19, wherein the cleat portion is in the form of a pair of parallel rows, each row having spaced-apart teeth-like projections.
